(19) United States
(12) Patent Application Publication
(10) Pub. No.: US 2005/0211683 A1
(43) Pub. Date: Sep. 29, 2005

(54) Robot for carrying out industrial operations by a laser beam

(75) Inventor: Stefano Deplano, Torino (IT)

Correspondence Address: YOUNG & BASILE, P.C., 3001 WEST BIG BEAVER ROAD, SUITE 624, TROY, MI, 48084, US

(73) Assignee: Comau, S.p.A., Grugliasco (Torino) (IT)

(21) Appl. No.: 11/084,905

(22) Filed: Mar. 21, 2005

(30) Foreign Application Priority Data
Mar. 23, 2004 (IT) TO2004A000193

(51) Int. Cl. B23K 26/08

(52) U.S. Cl. 219/121.78

(57) ABSTRACT

A robot for carrying out industrial operations by a laser beam has a structure including an arm articulated to a hollow wrist provided with a support for a laser focusing head. The power laser beam is supplied to the laser focusing head by means of an optical fiber including at least a portion guided inside the articulated arm and inside the hollow wrist and connected to an adjacent portion of an optical fiber by means of a rotary joint.

### SUMMARY OF THE INVENTION

The present invention relates to robots used for carrying out industrial operations by a laser beam, of the type comprising a structure including at least one articulated arm, having a tubular shape and ending with a robot wrist, the latter having again a substantially tubular hollow shape, wherein said wrist connects the aforesaid articulated arm to a support for mounting a laser focusing head thereon, so that said connection can rotate around one or more axes with respect to the terminal end of the articulated arm of the robot, said robot further comprising one or more electric motors for controlling the rotations of said robot wrist around said axes, and wherein said robot is further provided with a laser focusing head mounted onto said support and with an optical fiber for bringing a power laser beam from a laser generator to the aforesaid focusing head.

### BACKGROUND OF THE INVENTION

The same Applicant has been developing and marketing for a long time a robot of the type referred to above, in which the optical fiber supplying the laser beam to the laser focusing head is arranged outside the robot arm, thus being it necessary to arrange suitable supports outside the robot arm. The Applicant has also been using for a long time robots with hollow wrist of the type referred to above (see EP 0 873 826 B1) and comprising three tubular elements rotatably mounted each other around three respective coplanar axes, and wherein the intermediate forms builds an angle other than 90° with respect to each of the other two axes. In said known solution, electric supply cables and pipes for supply fluids associated to a tool (for instance an electric spot welding gun) mounted onto the support of the robot wrist are led through said hollow wrist. Said document does not mention or suggest to arrange through said hollow wrist also an optical fiber for supplying a power laser beam to a laser focusing head.

It was also proposed to use the through cavity of a robot hollow wrist for the passage of optical fibers designed for signal transmission to and from a device mounted onto the robot wrist support. This solution can be easily put into practice, since optical fibers designed for signal transmission have a relatively small diameter and are therefore more flexible, so that deformations undergone by them as a result of robot movements during its normal operation do not generate too high stresses onto said fibers.

Obviously, in practical embodiments optical fibers comprise a central core representing the real optical fiber and an outer protective coating. In the present description, the tern optical fibers refers both to the purely theoretical case of a “naked” optical fiber, and to the case of an optical fiber provided with a coating.

In order to propose a new robot for carrying out industrial operations through laser beam that is simpler and smaller than known robots and that is at the same time efficient and reliable, the object of the present invention is a robot having all the characteristics referred to above and further characterized in that the optical fiber supplying the laser power beam to the focusing head has at least one portion arranged inside the robot structure, and in particular inside the articulated arm and inside the robot hollow wrist.

Preferably, said portion of optical fiber has at least one end connected to an adjacent portion of optical fiber by means of a rotary joint. More preferably, the hollow wrist is of the type comprising three tubular elements rotatably in sequence relative to each other around three corresponding coplanar axes, in which the intermediate axis forms an angle other than 90° with respect to each of the other two axes.

### BRIEF DESCRIPTION OF THE DRAWINGS

The invention will now be described with reference to the accompanying drawings, provided as a mere non-limiting example, in which:

FIG. 1 is a sectional view of an articulated arm of an industrial robot according to the invention, provided with a hollow wrist, and

FIGS. 2-4 show variants of the articulated arm of FIG. 1.

### DETAILED DESCRIPTION OF THE INVENTION

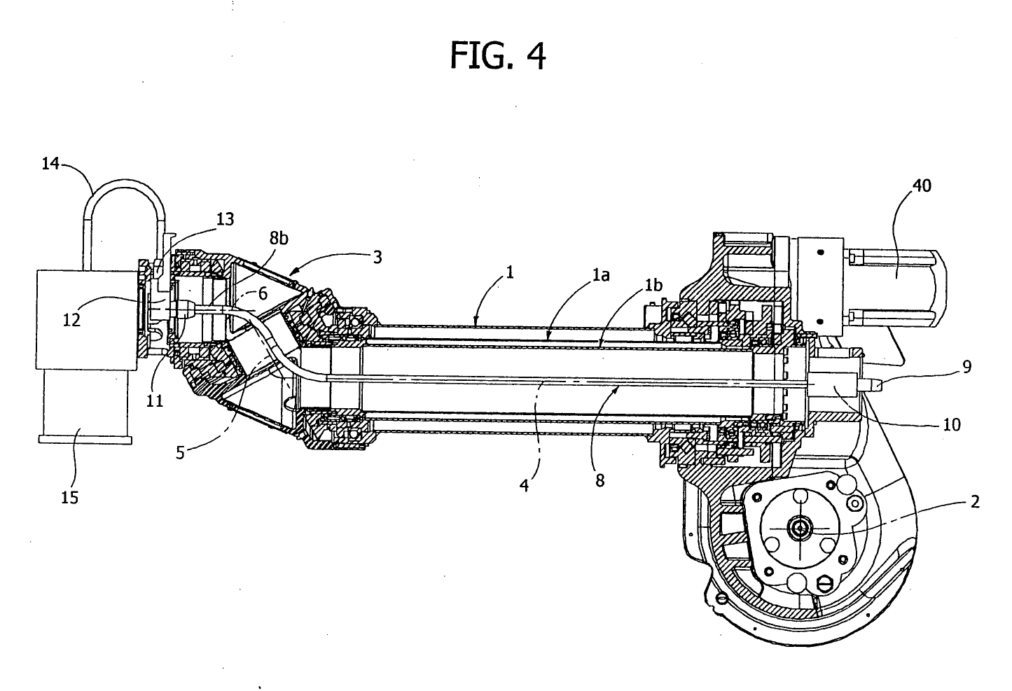

In the drawings number 1 refers globally to a robot articulated arm designed to be articulated around an axis 2 with respect to a robot adjacent structure. A robot wrist 3 with a general hollow shape is mounted at the distal end of the articulated arm. The structure of the hollow wrist 3 is basically the same as the one shown in the previous European patent EP 0 873 826 B1. This structure is not shown here in further detail since it is known per se and further since, taken per se, it does not fall within the scope of the invention. Let us just mention here the fact that the wrist 3 includes three tubular elements rotatably mounted in sequence relative to each other around respective axes 4, 5, 6, which are coplanar one to the other and are arranged as shown in the figure, the intermediate axis 5 forming an angle other than 90° with respect to each of the two axes 4, 6. The figure also shows one of the electric motors 40 which control the rotations of the wrist 3 by means of tubular, concentric drive shafts 1a, 1b arranged inside the structure of the arm 1 and on their turn defining an inner channel used to the purposes disclosed below. A support 7 for fastening a tool in the specific case a focusing head of a laser beam (shown only in FIG. 4) is mounted onto the end portion of the wrist 3,.

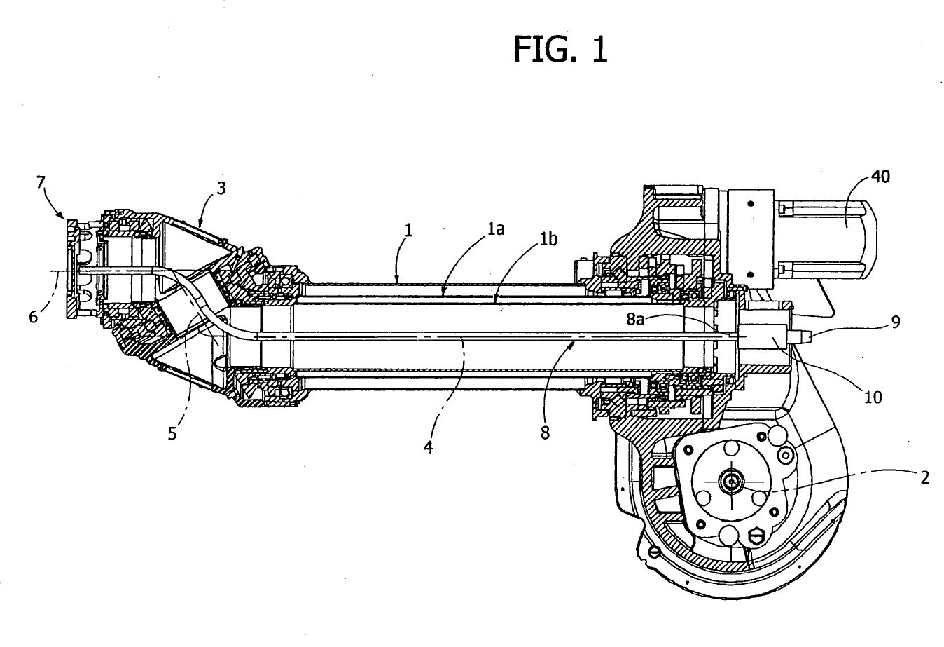

As can be clearly seen in FIG. 1, the inner cavity of the arm 1 and of the wrist 3 is used for fastening an optical fiber 8 (meaning the real optical fiber together with its coating) for supplying the laser power beam to the laser focusing head. In the drawings construction details of the laser focusing head mounted onto the support 7 are not shown since it can be made in any known way. For the same reason, FIG. 1 does not show the end portion of the optical fiber 8 connected to the laser focusing head. For the purposes of the invention, it should be pointed out that the optical fiber 8 is arranged inside the hollow wrist 3 and inside the arm 1. In order to protect said fiber from too high torsion deformations due to robot arm and wrist movements during normal operating steps, an end 8a of the optical fiber 8 is connected to an adjacent portion 9 of an optical fiber by means of a rotary joint 10. Said rotary joint 10 connecting the two optical fibers 8, 9 one to the other is shown only schematically in the drawings. Such a component is indeed known per se and available on the market. It can therefore be made in any way according to known techniques.

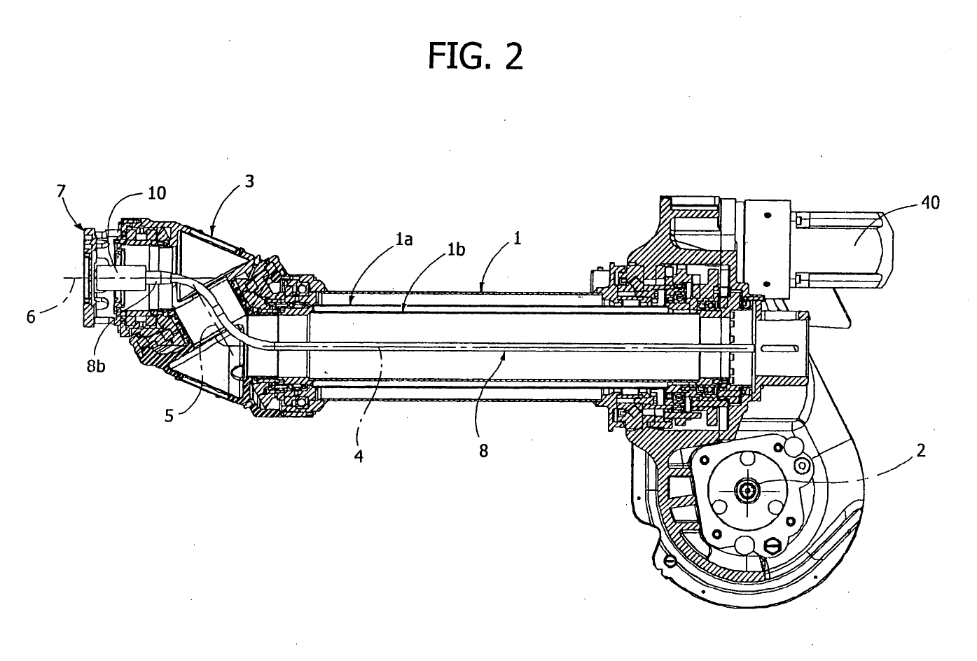

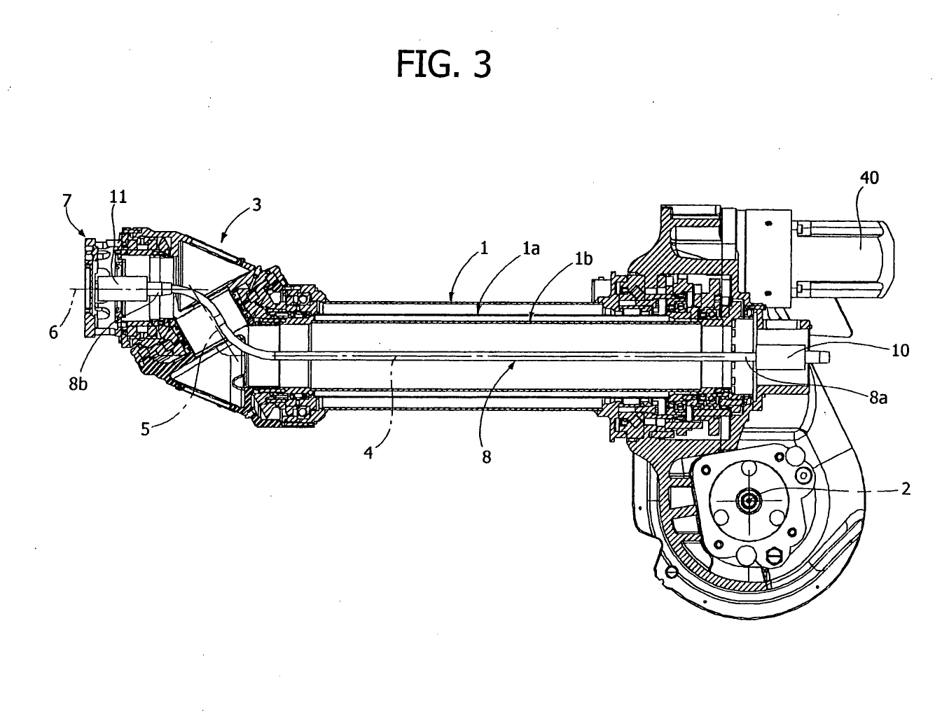

FIG. 2 differs from FIG. 1 in that the rotary joint 10 is arranged at the end 8b adjacent to the wrist, instead of being placed at the opposite end of the portion of optical fiber 8. FIG. 3 shows a further variant in which the portion of optical fiber 8 is provided with rotary joints at its both ends.

Finally, FIG. 4 shows a solution in which the optical fiber 8 is provided with a rotary joint 10 at its end 8a, whereas at the end 8b it is connected to the connector 11 of a device 12 including a reflecting mirror, for sending the laser power beam towards a radial connector 13 to which is connected a further element of an optical fiber 14, which sends the laser beam to the laser focusing head referred to with 15 in FIG. 4.

Obviously, though the basic idea of the invention remains the same, construction details and embodiments can widely vary with respect to what has been described and shown, through without leaving the framework of the present invention.

1. A robot for carrying out industrial operations by a laser beam, comprising a structure including at least one articulated arm, having a tubular shape and ending with a robot wrist, the latter having a substantially tubular hollow shape, in which said wrist connects the aforesaid articulated arm to a support for mounting a laser focusing head thereon, so that said support can rotate around one or more axes with respect to the terminal end of the articulated arm of the robot, said robot further comprising one or more electric motors for controlling the rotations of said robot wrist around said axes, and in which said robot is further provided with a laser focusing head mounted onto said connection and with an optical fiber for bringing a laser beam from a laser generator to the aforesaid focusing head, characterized in that the optical fiber supplying the power laser beam to the laser focusing head has at least one portion arranged inside the robot structure, and in particular inside the articulated arm and inside the hollow wrist of the robot.

2. The robot according to claim 1, wherein said portion of optical fiber has at least one end connected to an adjacent portion of an optical fiber through a rotary joint.

3. The robot according to claim 1, wherein said hollow wrist is of the type comprising three tubular elements rotatably mounted in sequence relative to each other around three respective coplanar axes, wherein the intermediate axis forms an angle other than 90° with respect to each of the other two axes.

4. The industrial robot according to claim 3, wherein said portion of optical fiber is provided with a rotary joint at its end adjacent to the robot wrist.

5. The industrial robot according to claim 3, wherein the aforesaid optical fiber portion is provided with said rotary joint at its end placed on the opposite side with respect to the robot wrist.

6. The industrial robot according to claim 3, wherein the aforesaid portion of optical fiber is provided with two rotary joints mounted onto its two ends adjacent to the hollow wrist and to the end of the articulated arm placed on the opposite side of the hollow wrist.

7. The industrial robot according to claim 3, wherein said optical fiber portion is provided with a rotary joint at one end opposite the hollow wrist, whereas close to the hollow wrist it is connected to a connector of a mirror reflecting device sending the power laser beam in a radial direction towards a further element of an optical fiber conveying the power laser beam to the laser focusing head.
